(19) United States
(12) Patent Application Publication
(10) Pub. No.: US 2025/0341391 A1
(43) Pub. Date: Nov. 6, 2025

(54) SENSING DEVICE AND SENSING METHOD

(71) Applicant: HITACHI, LTD., Tokyo (JP)

(72) Inventors: So SASATANI, Tokyo (JP); Tsuyoshi KITAMURA, Tokyo (JP)

(21) Appl. No.: 18/867,673

(22) PCT Filed: Apr. 20, 2023
(86) PCT No.: PCT/JP2023/015838

§ 371 Date: Nov. 20, 2024

(30) Foreign Application Priority Data
Aug. 1, 2022 (JP) 2022-122817

(51) Int. Cl. G01B 11/245; G06T 7/564; G06T 7/586; G06T 7/593; G06T 7/80

(52) U.S. Cl. CPC G01B 11/245; G06T 7/564; G06T 7/586; G06T 7/593; G06T 7/85; G06T 2207/10012; G06T 2207/10048

(57) ABSTRACT

A sensing device and sensing method accurately measure the three-dimensional shape of an object including a transparent material. A calculator generates an image on the basis of visual information of an object, extracts an area occupied by the object as an object area from the image, extracts distance information of an edge portion of the object from distance information of the object to generate edge distance information, generates a far-infrared image corresponding to the object area on the basis of far-infrared information of the object, controls a heating device to heat the object, estimates partial surface shape information of the object from the far-infrared images before and after the heating of the object, generates interpolated edge distance information of the object by interpolating the edge distance information using the partial surface shape information, and converts the interpolated edge distance information to three-dimensional shape information and outputs the three-dimensional shape information.

### TECHNICAL FIELD

The present invention relates to a sensing device and a sensing method.

### BACKGROUND ART

In recent years, there have been growing expectations for automated and autonomous system control to resolve the manpower shortage and improve productivity along with a declining birthrate and a growing proportion of elderly people. In the industrial and logistics fields, for example, there is a high demand for robots that can automatically pick up workpieces to be worked on. To automate picking work, it is necessary to use sensors such as cameras to measure the 3D shape of a workpiece and teach the robot the position information for grasping the workpiece. A common method of measuring 3D shapes is to use a plurality of cameras or a camera and a projector for measurement based on the principle of triangulation. The camera often uses a visible light sensor to accurately recognize the 3D shape of a packaging material such as paper that packs the workpiece. However, if the workpiece is packed in a transparent material such as a blister pack, the shape of the packaging part cannot be acquired, only the shape of the workpiece body inside is acquired, and a picking operation may crush and destroy the transparent packaging part. Therefore, an expected method of acquiring the 3D shapes of transparent parts may use not only a visible light sensor but also a far-infrared camera in combination. According to Patent Literature 1, for example, an imaging device fastened with a visible light camera and a far-infrared camera measures a workpiece at a plurality of points to acquire 3D shapes.

### CITATION LIST

### Patent Literature

Patent Literature 1: Japanese Unexamined Patent Application Publication No. 2019-032600

### SUMMARY OF INVENTION

### Technical Problem

The technology of Patent Literature 1 can correctly recognize the shape of the transparent part of a workpiece whose body is packed in a transparent material, and pick the workpiece without destroying the packaging. However, acquisition of a plurality of images by moving the imaging device not only depends on the calibration accuracy, but also wastes time to pick one workpiece, and could lead to degrade the efficiency of the entire system.

The present invention has been made in consideration of the foregoing and aims to provide a sensing device and a sensing method capable of accurately measuring 3D shapes of an object including a transparent material.

### Solution to Problem

To achieve the above-described object, a sensing device according to the present invention measures a three-dimensional shape of an object and includes a computer and a heating device.

The computer includes an image generation portion to generate an image based on visual information on the object, an object region extraction portion to extract an object region that belongs to the image and is occupied by the object, an edge distance information generation portion to extract distance information on an edge part of the object out of distance information on the object and generate edge distance information, a far-infrared image generation portion to generate a far-infrared image corresponding to the object region based on far-infrared information on the object, a heating device control portion to control the heating device to heat the object, a partial surface shape estimation portion to estimate partial surface shape information on the object from far-infrared images before and after the object is heated, a shape interpolation portion to interpolate the edge distance information by using the partial surface shape information and generate interpolated edge distance information on the object, and an object shape output portion to convert the interpolated edge distance information into 3D shape information and output it.

A sensing method of measuring 3D shapes of an object includes the steps of generating an image of the object based on visual information on the object 30; extracting an object region occupied by the object in the image; extracting distance information on an edge part of the object out of distance information on the object to generate edge distance information; generating a far-infrared image corresponding to the object region based on far-infrared information on the object; heating the object; generating a far-infrared image of the object after heating the object; estimating partial surface shape information on the object based on far-infrared images before and after heating the object; generating interpolated edge distance information on the object by interpolating edge distance information through the use of the partial surface shape information; and converting the interpolated edge distance information into 3D shape information.

The present invention configured as above can generate partial surface shape information on an object from far-infrared images of the object before and after heating, interpolate edge distance information on the object by using the partial surface shape information, and thereby accurately measure 3D shapes of the object including a transparent material.

### Advantageous Effects of Invention

The present invention can accurately measure 3D shapes of an object including a transparent material.

### BRIEF DESCRIPTION OF DRAWINGS

FIG. 1 is a configuration diagram illustrating a sensing device and a sensing system according to a first embodiment of the present invention.

FIG. 2 is a functional block diagram illustrating an object region extraction portion.

FIG. 3 is a diagram illustrating the process of an edge distance information generation portion.

FIG. 4 is a diagram illustrating edge distance information generated by the edge distance information generation portion.

FIG. 5 is a diagram illustrating the process of a far-infrared image generation portion.

FIG. 6 is a diagram illustrating the process of a partial surface shape estimation portion.

FIG. 7 is a functional block diagram illustrating a shape interpolation portion.

FIG. 8 is a diagram illustrating the process of the shape interpolation portion.

FIG. 9 is a configuration diagram illustrating a picking robot system according to a second embodiment of the present invention.

### DESCRIPTION OF EMBODIMENTS

The description below explains the embodiments of the present invention by reference to the drawings. In each drawing, the same reference numerals are used to designate equivalent elements, and duplicated descriptions will be omitted as appropriate.

### First Embodiment

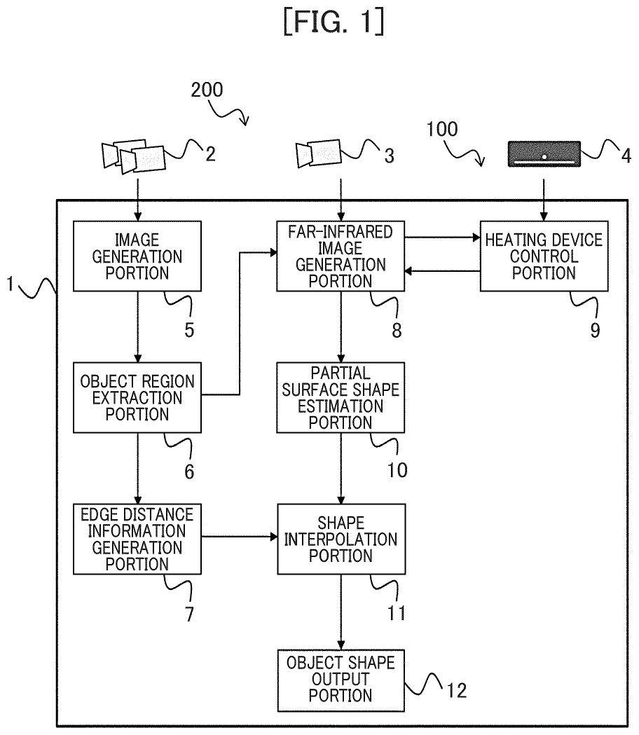

FIG. 1 is a configuration diagram illustrating a sensing device and a sensing system according to a first embodiment of the present invention. A sensing device 100 illustrated in FIG. 1 measures the 3D shapes of an object and includes a computer 1 and a heating device 4. In FIG. 1, the functions of function portions 5 through 12 of the computer 1 are implemented in the computer 1 which includes an arithmetic device, a main storage device, and an external storage device.

The sensing device 100 measures the 3D shape of an object based on visual information, distance information, and far-infrared information on the object. It is advantageous to use a visible light sensor as a means to acquire visual information and distance information on the object. According to the present embodiment, the visible light sensor uses a stereo camera 2 but is not limited thereto. Instead, it is also possible to use a sensor that is equipped with a projector adjacent to the visible light camera to measure distance information or a sensor that uses machine learning to estimate distance information based on images from the visible light camera, for example. A sensing system 200 is composed of the sensing device 100, a visible light sensor 2, and a far-infrared sensor 3.

The description below outlines the function portions 5 through 12 illustrated in FIG. 1. The image generation portion 5 performs a function of generating two images based on information acquired by visible light cameras provided at the right and left of the stereo camera 2; the object region extraction portion 6 performs a function of extracting an object region in images by analyzing two images generated by the image generation portion 5; the edge distance information generation portion 7 performs a function of analyzing distance information corresponding to the object region and extracting distance information on edges of the object; the far-infrared image generation portion 8 performs a function of using the far-infrared camera 3 to generate a far-infrared image corresponding to the object region; the heating device control portion 9 performs a function of controlling the heating device 4 to heat the object region; the partial surface shape estimation portion 10 performs a function of analyzing the far-infrared images of the object region before and after heating generated by the far-infrared image generation portion 8 and estimating a partial surface shape of the object region; the shape interpolation portion 11 performs a function of using the estimated surface shape and interpolating the edge distance information generated by the edge distance information generation portion 7; and the object shape output portion 12 performs a function of converting the interpolated edge distance information into 3D shape information and outputting it. The function portions 6 through 12 are explained in detail below.

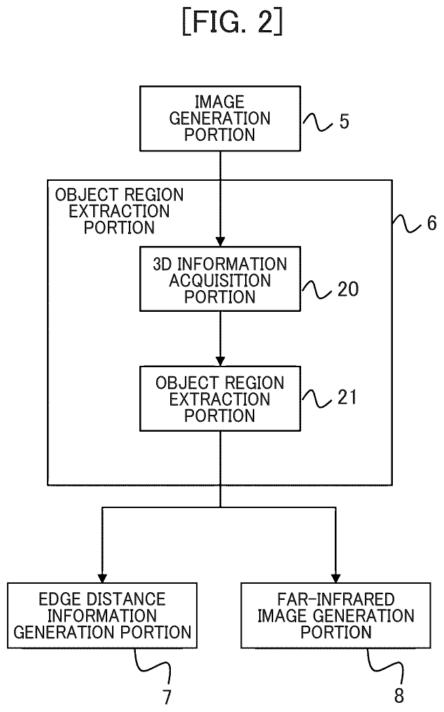

FIG. 2 is a functional block diagram illustrating an object region extraction portion 6. The object region extraction portion 6 includes a 3D information acquisition portion 20 that acquires 3D information from an image captured by the stereo camera 2 and generated by the image generation portion 5 and an object region extraction portion 21 that analyzes the acquired 3D information and extracts an object region in the image. The 3D information acquisition portion 20 acquires 3D information by calculating a disparity from the captured image of the stereo camera 2. A general method such as block matching calculates disparities. The calculated disparity information is converted into 3D information such as point cloud information in a 3D space from the parameters such as the camera installation position and orientation information. Without limitation to this method, any method is available if the method can acquire 3D information from two camera images.

The object region extraction portion 21 extracts an object region from the camera image and the 3D information. The extraction method is not particularly limited and may include, for example, a method of extracting an object region using a difference region between a camera image including the object and a camera image of a previously captured background devoid of object; a method of extracting an object region using a difference region between 3D information calculated in the presence of an object and 3D information calculated in the absence of an object; and a method of extracting the final object region using a common part between the object region acquired based on the image and the object region acquired based on the 3D information.

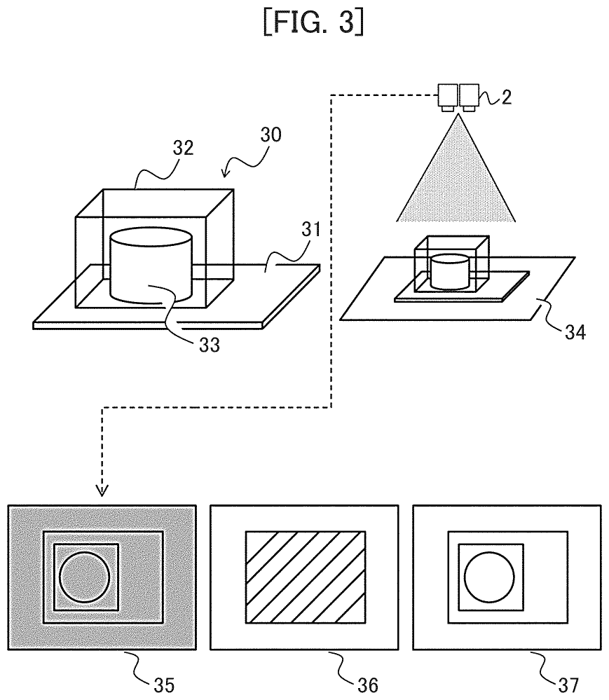

FIG. 3 is a diagram illustrating the process of an edge distance information generation portion 7. In FIG. 3, reference numeral 30 denotes an example of object (hereafter, workpiece) to be picked by a robot; reference numeral 31 denotes part of a packing material made of paper for the workpiece 30; reference numeral 32 denotes part of a transparent packing material (such as plastic or glass) for the workpiece 30; reference numeral 33 denotes a workpiece body packed with the packing materials 31 and 32; reference numeral 34 denotes a pedestal to place the workpiece 30 when the sensing device 100 is used for measurement; reference numeral 35 denotes an example of a captured image of one visible light camera 2 when the stereo camera 2 captures the workpiece 30 on the pedestal 34; reference numeral 36 denotes an object region the object region extraction portion 6 extracts from the captured image; and reference numeral 37 denotes edge distance information generated by the edge distance information generation portion 7.

The edge distance information generation portion 7 generates edge distance information on the workpiece 30 by analyzing the 3D information in the object region 36. The description below explains an example method of generating the edge distance information. First, a distance value from the stereo camera 2 at the position corresponding to each pixel of the captured image 35 is found from the 3D information, and information connecting the distance value to each pixel is generated as a distance image. Then, the distance value of each pixel in the distance image is compared with the distance values of pixels adjacent above, below, left, and right, if a difference between the compared values is greater than or equal to a threshold, the pixel is extracted as an edge part, and information connecting the smaller one of the compared distance values to the pixel of the edge part is generated as the edge distance information.

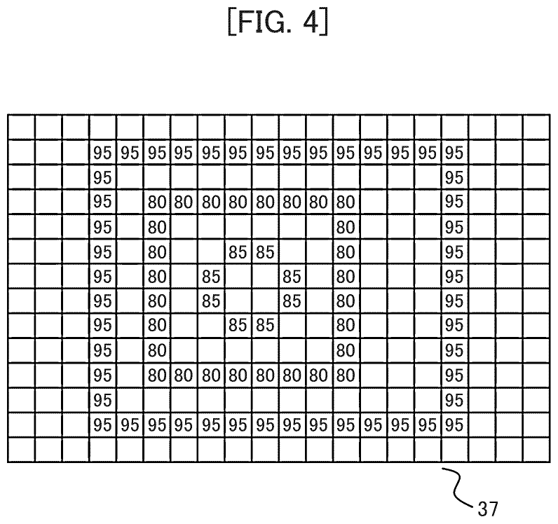

FIG. 4 is a diagram illustrating edge distance information 37 generated by the edge distance information generation portion 7. Each pixel in the edge part stores a distance value (in units of cm) from the camera, and no value is stored in each pixel except for the edge part. The edge distance information 37 makes it possible to express distance information on the outer part of the workpiece 30 and acquire distance information on the outer frames of the transparent packing materials 31 and 32. Without limitation to this example, any method is available if it can acquire distance information corresponding to the edge part of the workpiece 30. In terms of the distance image resolution, an image comparable to the captured image may be used, or a distance image with reduced resolution by downsampling may be used, for example.

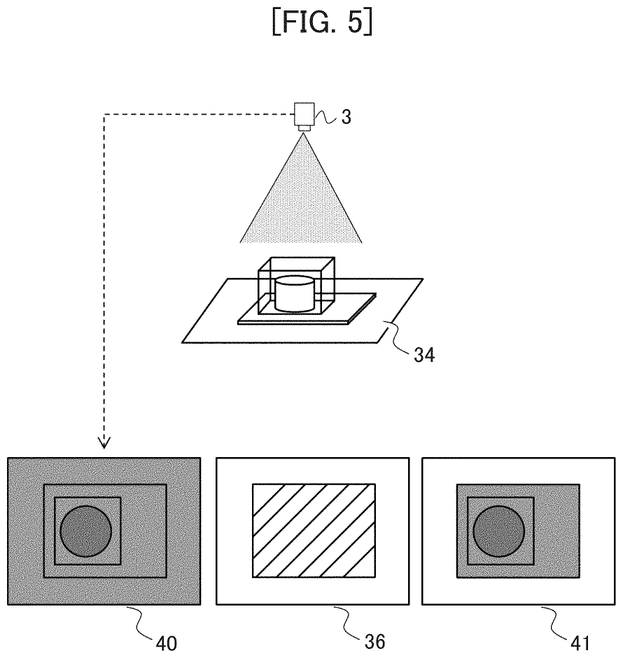

FIG. 5 is a diagram illustrating the process of a far-infrared image generation portion 8. In FIG. 5, reference numeral 40 denotes far-infrared images of the workpiece 30 and the pedestal 34 generated based on information from the far-infrared camera 3, and reference numeral 41 denotes a far-infrared image corresponding to the object region 36 extracted from the far-infrared image 40. The far-infrared image includes temperature information, which varies with different materials. The far-infrared image is information connecting a temperature value to each pixel and is treated as image information similar to a captured image or a distance image. The far-infrared image resolution is not particularly limited and an image comparable to the captured image or a low-resolution image may be used.

Returning to FIG. 1, the heating device control portion 9 allows the heating device 4 to heat the workpiece 30. Ideally, the heating device 4 is installed close to the stereo camera 2 or the far-infrared camera 3 and ensures the same direction (directly above the workpiece 30 in this example) to capture the workpiece 30, but there is no particular limitation as long as a measure is capable of heating the workpiece 30 from the same direction as the camera to capture the workpiece 30. According to the present embodiment, a hot air device is assumed as the heating device 4, but there is no particular limitation as long as a device is capable of increasing the temperature of the workpiece 30. In the sensing device 100, when the heating device 4 completely heats the workpiece 30, the heating device control portion 9 transmits a command to the far-infrared image generation portion 8 so that the far-infrared camera 3 measures the workpiece 30, thus generating far-infrared images of the workpiece 30 before and after heating. The method of heating by the heating device 4 is not particularly limited and may be available as a method of heating each time at a predetermined time; a method of estimating an approximate distance from the heating device 4 to the object 30 based on previously generated edge distance information or far-infrared image and changing the heating time according to the distance; a method of shortening the heating time when the temperature value in the far-infrared image is generally high based on a determination that the workpiece 30 is made of a material that is easy to heat; or a method of adjusting the heating time or heating direction according to the prior information (such as shape, dimensions, or material) about the workpiece 30.

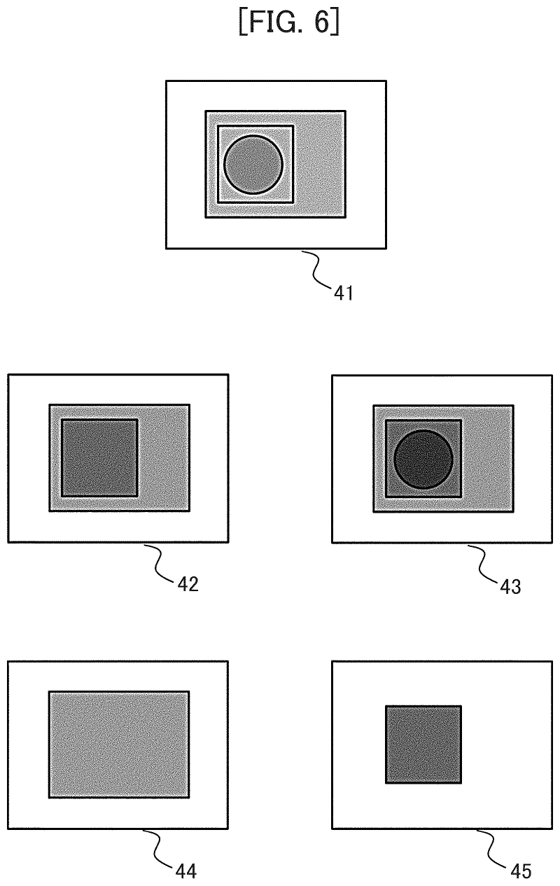

FIG. 6 is a diagram illustrating the process of a partial surface shape estimation portion 10. In FIG. 6, reference numeral 41 denotes an example far-infrared image corresponding to the work area (object region) before heating illustrated in FIG. 5; reference numerals 42 and 43 denote example far-infrared images corresponding to the work area after heating by the heating device control portion 9; and reference numerals 44 and 45 denote example partial surface shape information output by the partial surface shape estimation portion 10. The heating device 4 is installed close to the far-infrared camera 3 and heats the work 30 from directly above, and part of the work 30 at a high position (the part close to the far-infrared camera 3 or the stereo camera 2) is heated faster and greatly changes the temperature. Regarding the work 30 in this example, the transparent packaging part is located closest to the heating device 4 and generates the highest temperature as indicated by reference numeral 42. The paper part of the workpiece 30 is also heated to change the temperature, making it possible to measure the region of the paper material. The workpiece body 33 made of a material that heats up hardly decreases the temperature lower than the transparent packaging part as indicated by reference numeral 42, making it impossible to measure the region of the workpiece body 33. A material that heats up easily increases the temperature higher than the transparent packaging part as indicated by the far-infrared image 43, making it possible to measure the region of the workpiece body 33. The region of the workpiece body 33 in the far-infrared image 43 causes a noise while the present invention aims to acquire the region of the transparent packaging part. It may be favorable to use the far-infrared image 41 generated before heating and apply a noise removal process such as eliminating the region indicating a temperature value greater than or equal to a threshold before heating from the far-infrared image 43 generated after heating. The partial surface shape estimation portion 10 outputs regions indicating similar temperature values as partial surface shape information 44 and 45 from the finally heated far-infrared image 42 to which the noise removal has been applied, for example. The extraction of the partial surface shape information may use not only the temperature value but also the position information on the region. When a plurality of regions indicate similar temperature values and are located apart from each other to exceed a predetermined threshold, it may be favorable to output the separate partial surface shape information for each. There is no particular limitation.

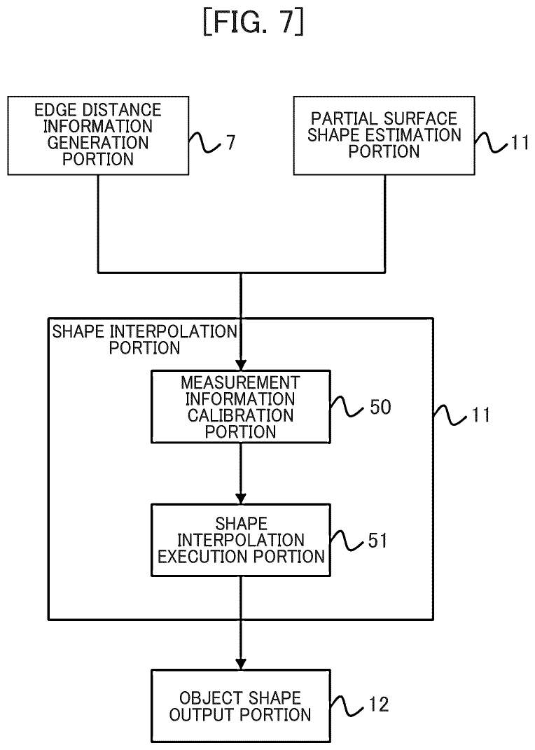

FIG. 7 is a functional block diagram illustrating a shape interpolation portion 11. The shape interpolation portion 11 includes a measurement information calibration portion 50 that calibrates two pieces of measurement information, namely, the edge distance information generated based on information from the stereo camera 2 and the partial surface shape information estimated based on information from the far-infrared camera 3, to information in the same sensor space; and a shape interpolation execution portion 51 that compares the calibrated measurement information to interpolate the 3D shape of the workpiece. The description below explains the measurement information calibration portion 50 and the shape interpolation execution portion 51.

The measurement information calibration portion 50 calibrates the edge distance information and the partial surface shape information to information in the same sensor space based on information such as installation positions, posture information, and resolutions of the stereo camera 2 and the far-infrared camera 3. Since the present example treats each measurement information as image information, the calibration method resizes an image so that the resolution matches one size, and then converts the coordinate information of each measurement information in the same space by using a rotation matrix or translation vector between the sensors found by a calibration technique using general check markers, for example. In terms of resolution resizing, there is no particular limitation on whether the resolution should match the edge distance information or the partial surface shape information. There is no particular limitation on the calibration method as long as the method is capable of the coordinate conversion that can compare the edge distance information illustrated in FIG. 4 with the partial surface shape information 44 and 45 illustrated in FIG. 6. When each measurement information is treated as image information like in this example, it may be favorable to use a coordinate conversion method in the 2D space such as alignment between images.

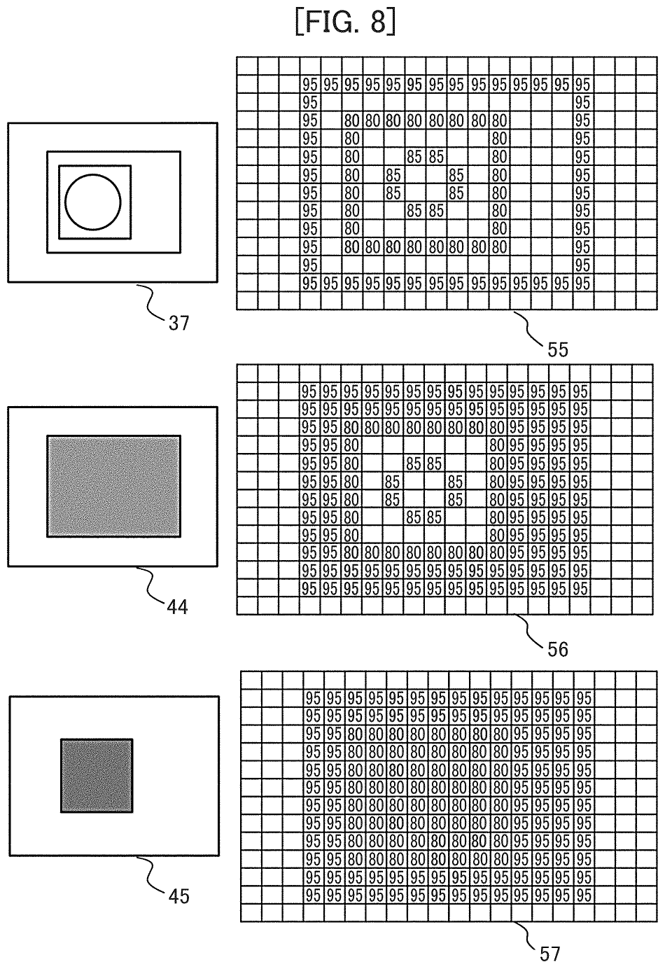

FIG. 8 is a diagram illustrating the process of the shape interpolation execution portion 51. In FIG. 8, reference numeral 55 illustrates the initial edge distance information in which the edge distance information 37 includes distance values of the edge parts and reference numerals 56 and 57 illustrate the interpolated edge distance information interpolated by the shape interpolation execution portion 51. The shape interpolation execution portion 51 interpolates the initial edge distance information 55 by using the partial surface shape information 44 and 45 calibrated by the measurement information calibration portion 50. The interpolation is performed by comparing the partial surface shape information 44 and 45 with the edge distance information 37 and then using a fitting process, for example, to determine to which edge part of the edge distance information 37 the outer periphery of each partial surface shape information corresponds. The initial edge distance information 55 is interpolated by comparing the values of the initial edge distance information 55 corresponding to the outer periphery of the partial surface shape information and using the partial surface shape information distant from the stereo camera 2 in order. The order of the partial surface shape information used for the interpolation may be determined by using the size of the partial surface shape information instead of using the distance from the stereo camera 2. There is no particular limitation on the interpolation as long as the method fills blanks with values of the initial edge distance information 55. For example, the method may use, as a reference distance value, the distance value in the edge distance information corresponding to the outer periphery of the partial surface shape information and repeatedly fill blanks, if any, around (up, down, left, right) each pixel with the reference distance values inside the object region until finding a pixel containing a distance value smaller than the reference distance value. According to this example, a comparison between the partial surface shape information 44 and 45 as to the edge distance information on the outer periphery reveals that the partial surface shape information 44 contains a distance value 15 cm larger. The partial surface shape information 44 is used to interpolate the initial edge distance information 55 and generate the interpolated edge distance information 56. The partial surface shape information 45 is used for the interpolated edge distance information 56 to interpolate the edge distance information and generate the interpolated edge distance information 57. The present example finds a pixel containing a distance value (85) greater than a reference distance value (80) while filling in blanks in the interpolated edge distance information 56. The distance value of the pixel is overwritten with the reference distance value (80) to generate the final interpolated edge distance information 57.

The object shape output portion 12 generates a 3D point cloud from the interpolated edge distance information generated by the shape interpolation portion 11 and outputs the 3D point cloud as the final 3D shape information of the workpiece.

### SUMMARY

According to the present embodiment, the sensing device 100 to measure 3D shapes of the object 30 includes the computer 1 and the heating device 4. The computer 1 includes: the image generation portion 5 to generate an image 35 of the object 30 based on visual information of the object 30; the object region extraction portion 6 to extract the region of the image 35 occupied by the object 30 as the object region 36; the edge distance information generation portion 7 to extract distance information on the edge part of the object 30 out of the distance information on the object 30 and generate the edge distance information 37; the far-infrared image generation portion 8 to generate far-infrared images 41 through 43 corresponding to the object region 36 based on far-infrared information on the object 30; the heating device control portion 9 to control the heating device 4 to heat the object 30; the partial surface shape estimation portion 10 to estimate the partial surface shape information 44 and 45 on the object 30 based on the far-infrared images 41 through 43 before and after heating the object 30; the shape interpolation portion 11 to generate the interpolated edge distance information 57 on the object 30 by interpolating the edge distance information 37 through the use of the partial surface shape information 44 and 45; and the object shape output portion 12 to convert the interpolated edge distance information 57 into 3D shape information and output it.

The sensing system 200 according to the present embodiment includes the sensing device 100, the visible light sensor 2 to acquire visual information and distance information on the object 30, and the far-infrared sensor 3 to acquire far-infrared information on the object 30.

According to the present embodiment, a sensing method of measuring 3D shapes of an object includes the steps of generating an image 35 of the object 30 based on the visual information on the object 30; extracting the object region 36 occupied by the object 30 in the image 35; extracting distance information on the edge part of the object 30 out of the distance information on the object 30 to generate the edge distance information 37; generating the far-infrared image 41 corresponding to the object region 36 based on the far-infrared information on the object 30; heating the object 30; generating the far-infrared images 42 and 43 after heating the object 30; estimating the partial surface shape information 44 and 45 on the object 30 based on the far-infrared images 41 through 43 before and after heating the object 30; generating the interpolated edge distance information 57 on the object 30 by interpolating edge distance information 37 through the use of the partial surface shape information 44 and 45; and converting the interpolated edge distance information 57 into the 3D shape information.

The present embodiment configured as above generates the partial surface shape information 44 and 45 on the object 30 from the far-infrared images 41 through 43 before and after heating the object 30 and interpolates the edge distance information 37 on the object 30 by using the partial surface shape information 44 and 45, thereby making it possible to accurately measure the 3D shape of the object 30 including transparent materials.

The edge distance information generation portion 7 according to the present embodiment calculates a distance value at a position corresponding to each pixel of the image 35 from the visible light sensor 2, generates a distance image which is information connecting the distance value to each pixel of the image 35, calculates a difference in distance values between pixels indicating the adjacent distance images, and extracts a pixel configuring the edge part, namely, a pixel whose difference is greater than or equal to a predetermined threshold, and generates the edge distance information 37 that connects each pixel configuring the edge part to a distance value of each pixel or a distance value of an adjacent pixel whichever is smaller. Then, it is possible to generate the edge distance information 37 from the information acquired by the visible light sensor 2.

The far-infrared image generation portion 8 according to the present embodiment generates the far-infrared image 41 which is information connecting each pixel of the object region 36 to far-infrared information on the object 30. Then, it is possible to acquire the far-infrared image 41 corresponding to the object region 36.

The heating device control portion 9 according to the present embodiment adjusts the heating time or heating direction of the heating device 4 on the object 30 based on at least one of the following: the object region 36, the edge distance information 37, the far-infrared image 41 before heating the object 30, and the prior information on the object 30. Then, it is possible to heat the object 30 to a temperature state appropriate for estimating the partial surface shape information 44 and 45.

The partial surface shape estimation portion 10 according to the present embodiment estimates the partial surface shape information 44 and 45 on the object 30 by using the far-infrared image 41 before heating the object 30 to remove noise contained in the far-infrared image 43 after heating the object 30. Then, it is possible to improve the accuracy of estimating the partial surface shape information 44 and 45.

The shape interpolation portion 11 according to the present embodiment includes a measurement information calibration portion 50 that calibrates the edge distance information 37 and the partial surface shape information 44 and 45 by converting the coordinates of the edge distance information 37 and the partial surface shape information 44 and 45 into coordinates in the same space; and a shape interpolation execution portion 51 that interpolates the calibrated edge distance information 37 by using the calibrated partial surface shape information 44 and 45. Therefore, it is possible to improve the accuracy of interpolating the edge distance information 37.

The partial surface shape information 44 and 45 according to the present embodiment includes a plurality of pieces of partial surface shape information 44 and 45 corresponding to a plurality of partial surface shapes, and the shape interpolation portion 11 determines the order of using the plurality of pieces of the partial surface shape information 44 and 45 for interpolation of the edge distance information 37, based on each distance from the visible light camera 2 to the plurality of partial surface shapes or each size of the plurality of partial surface shapes. Therefore, it is possible to improve the accuracy of interpolating the edge distance information 37.

The visible light sensor 2 according to the present embodiment is composed of a visible light camera equipped with a stereo camera and a projector or a visible light camera having the function of estimating distances from an image. Then, it is possible to simultaneously acquire visual information and distance information on the object 30.

The present embodiment has described examples of the workpiece whose partial surface shape is rectangular, but the shape of the workpiece is not particularly limited. When the transparent packaging part is hemispherical, for example, the far-infrared information after heating signifies that the vertex closest to the camera shows the highest temperature and an increase in the distance from the camera decreases the temperature. In this case, it is possible to generate the edge distance information for the part indicating the lowest temperature. The associated reference distance value may be used to estimate the partial surface shape information based on a method such as interpolation using 3D information estimated from the far-infrared image. Alternatively, it may be favorable to use a method of maintaining a model of the far-infrared image corresponding to each object shape category, generating a 3D model from the far-infrared image, and using the edge distance information to estimate the partial surface shape information.

### Second Embodiment

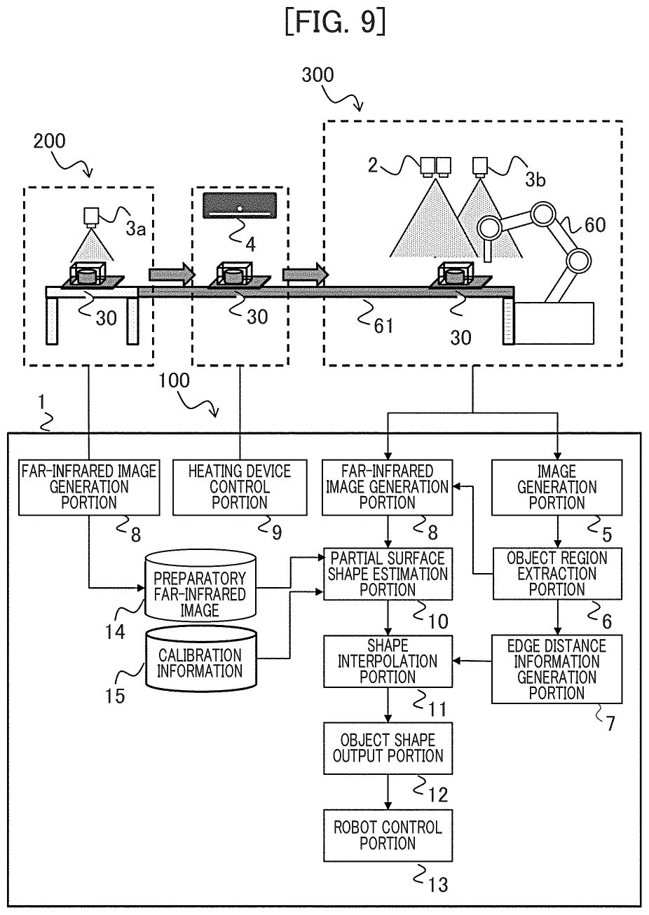

FIG. 9 is a configuration diagram illustrating a picking robot system according to a second embodiment of the present invention. A picking robot system 300 illustrated in FIG. 9 includes a picking robot 60, a belt conveyor 61, and the sensing system 200. The picking robot system 300 uses the sensing system 200 to measure the 3D shape of the workpiece 30 transported on the belt conveyor 61 and uses the picking robot 60 to grasp and transport the workpiece 30.

In FIG. 9, the far-infrared camera 3a, the heating device 4, and the picking robot 60 are installed near the belt conveyor 61 in this order from the upstream to the downstream of the belt conveyor 61. The stereo camera 2 and the far-infrared camera 3b are installed near the picking robot 60.

In FIG. 9, the image generation portion 5, the object region extraction portion 6, the edge distance information generation portion 7, the far-infrared image generation portion 8, the heating device control portion 9, the shape interpolation portion 11, and the object shape output portion 12 provide the functions same as or similar to those in the first embodiment. The robot control portion 13 provides a function of controlling the picking robot 60 based on the 3D shape information on the workpiece 30 output from the object shape output portion 12 and gripping and transporting the workpiece 30 to a predetermined position. The preparatory far-infrared image 14 is generated for the workpiece 30 before the workpiece 30 is heated. The calibration information 15 provides parameter information to calibrate the measurement information on the far-infrared cameras 3a and 3b. The description below explains the partial surface shape estimation portion 10 and the robot control portion 13.

The partial surface shape estimation portion 10 provides almost the same functions as the partial surface shape estimation portion 10 (see FIG. 1) according to the first embodiment, and generates the partial surface shape information from the preparatory far-infrared image 14 and the far-infrared image measured by the far-infrared camera 3b near the picking robot 60. The far-infrared cameras 3a and 3b perform calibration in advance to generate calibration information 15, based on the method described for the measurement information calibration portion 50 (see FIG. 7) so that the measurement information of each camera can be processed in the same coordinate space. The calibration information 15 can be used to express the measurement information of the far-infrared camera 3a and the stereo camera 2 in the same coordinate space. Therefore, a comparison between the preparatory far-infrared image 14 and an object region extracted by the object region extraction portion 6 can generate a far-infrared image before heating corresponding to the object region and estimate partial surface shape information according to a flow similar to that in the first embodiment.

The robot control portion 13 allows the picking robot 60 to transport the workpiece 30 by using the 3D shape information of the workpiece 30 output from the object shape output portion 12. In this example, the stereo camera 2 measures and acquires the acquired 3D shape information. The picking robot 60 and the stereo camera 2 need to be calibrated in advance. The calibration method is not particularly limited and may include a method of equipping the arm of the picking robot 60 with a calibration board, using the stereo camera 2 for measurement, and estimating the calibration information. The robot control portion 13 treats the 3D shape information as 3D point cloud coordinates and instructs the picking robot 60 in coordinate information on the gripping position and the transporting position to transport the workpiece 30. There are no particular limitations on the method of determining the gripping position and the transporting position. There are no particular limitations on the shapes of the arm part used for grasping. The arm part may be available in the shape of not only a humanlike hand but also a suction arm using a vacuum pump.

### SUMMARY

According to the present embodiment, in the picking robot system 300 including the sensing system 200, the picking robot 60, and the belt conveyor 61 that transports the object 30 to the picking robot 60, the far-infrared sensors 3a and 3b include the first far-infrared sensor 3a that acquires far-infrared information on the object 30 before it is heated by the heating device 4; and the second far-infrared sensor 3b that acquires far-infrared information on the object 30 after it is heated by the heating device 4. The computer 1 includes the robot control portion 13 which controls the picking robot 60 by using 3D shape information on the object 30.

The present embodiment configured as above generates a partial surface shape of the object 30 from far-infrared information on the object 30 before heating measured by the first far-infrared sensor 3a and far-infrared information on the object 30 after heating measured by the second far-infrared sensor 3b and uses the partial surface shape to interpolate the edge distance information on the object 30 measured by the visible light sensor 2, thereby making it possible to accurately measure the 3D shape of the object 30 including transparent materials while maintaining the efficiency of the entire system.

According to the present embodiment, the computer 1 stores the edge distance information in association with the partial surface shape information each time the object 30 is measured. If the newly generated edge distance information matches the previously generated edge distance information, it may be favorable to omit the heating of the object 30 by the heating device 4 and the acquisition of far-infrared information by the far-infrared sensors 3a and 3b, interpolate the newly generated edge distance information by using the partial surface shape information corresponding to the previously generated edge distance information, and thereby generate 3D shape information on the object 30. Then, it is possible to improve the efficiency of the entire system.

While there have been described in detail the embodiments of the present invention, the invention is not limited to the above-described embodiments and includes various modifications. For example, the embodiments above have been described in detail to explain the present invention in an easy-to-understand manner, and the invention is not necessarily limited to those having all the configurations described. It is also possible to add part of the configuration of one embodiment to the configuration of another embodiment, remove part of the configuration of one embodiment, or replace it with part of another embodiment.

### LIST OF REFERENCE SIGNS

1: computer, 2: stereo camera (visible light sensor), 3: far-infrared camera (far-infrared sensor) 3a: far-infrared camera (first far-infrared sensor), 3b: far-infrared camera (second far-infrared sensor), 4: heating device, 5: image generation portion, 6: object region extraction portion, 7: edge distance information generation portion, 8: far-infrared image generation portion, 9: heating device control portion, 10: partial surface shape estimation portion, 11: shape interpolation portion, 12: object shape output portion, 13: robot control portion, 14: preparatory far-infrared image, 15: calibration information, 21: object region extraction portion, 30: workpiece (object), 31, 32: packing material, 33: workpiece body, 34: pedestal, 35: captured image, 36: object region, 37: edge distance information, 40 to 43: far-infrared image, 44, 45: partial surface shape information, 50: measurement information calibration portion, 51: shape interpolation execution portion, 55: initial edge distance information, 56, 57: interpolated edge distance information, 60: picking robot, 61: belt conveyor, 100: sensing device, 200: sensing system, 300: picking robot system

1. A sensing device to measure a three-dimensional shape of an object, comprising:
a computer; and
a heating device,
wherein the computer includes:
an image generation portion to generate an image based on visual information on the object:
an object region extraction portion to extract an object region that belongs to the image and is occupied by the object:
an edge distance information generation portion to extract distance information on an edge part of the object out of distance information on the object and generate edge distance information:
a far-infrared image generation portion to generate a far-infrared image corresponding to the object region based on far-infrared information on the object:
a heating device control portion to control the heating device to heat the object:
a partial surface shape estimation portion to estimate partial surface shape information on the object from far-infrared images before and after the object is heated:
a shape interpolation portion to interpolate the edge distance information by using the partial surface shape information and generate interpolated edge distance information on the object; and
an object shape output portion to convert the interpolated edge distance information into 3D shape information and output it.

2. The sensing device according to claim 1,
wherein the far-infrared image generation portion generates, as the far-infrared image, information that connects far-infrared information on the object to each pixel in the object region.

3. The sensing device according to claim 1,
wherein the heating device control portion adjusts the heating time or heating direction of the heating device on the object based on at least one of the object region, the edge distance information, the far-infrared image before heating the object, and prior information on the object.

4. The sensing device according to claim 1,
wherein, when estimating a partial surface shape of the object, the partial surface shape estimation portion uses the far-infrared image before heating the object to eliminate noise from the far-infrared image after the object is heated.

5. The sensing device according to claim 1,
wherein the shape interpolation portion includes:
a measurement information calibration portion that converts coordinates of the edge distance information and the partial surface shape information into coordinates in the same space to calibrate the edge distance information and the partial surface shape information; and
a shape interpolation execution portion that interpolates the calibrated edge distance information by using the calibrated partial surface shape information.

6. A sensing system comprising:
the sensing device according to claim 1;
a visible light sensor that acquires visual information and distance information on the object; and
a far-infrared sensor that acquires far-infrared information on the object.

7. The sensing system according to claim 6,
wherein the edge distance information generation portion:
calculates a distance value at a position corresponding to each pixel of the image from the visible light sensor;
generates, as a distance image, information connecting the distance value to each pixel in the image;
calculates a difference in distance values between adjacent pixels in the distance image;
extracts, as a pixel constituting the edge portion, a pixel whose difference is greater than or equal to a predetermined threshold; and
generates the edge distance information that connects each pixel constituting the edge part to a distance value of each pixel or a distance value of an adjacent pixel whichever is smaller.

8. The sensing system according to claim 6,
wherein the partial surface shape information includes a plurality of pieces of partial surface shape information corresponding to a plurality of partial surface shapes, and
wherein the shape interpolation portion determines an order of using the plurality of pieces of partial surface shape information for interpolation of the edge distance information based on each distance from the visible light sensor to the plurality of partial surface shapes or each size of the plurality of partial surface shapes.

9. The sensing system according to claim 6,
wherein the visible light sensor is composed of a stereo camera, a visible light camera equipped with a projector, or a visible light camera having a function of estimating distance from an image.

10. A picking robot system comprising:
the sensing system according to claim 6;
a picking robot; and
a belt conveyor that transports the object to the picking robot,
wherein the far-infrared sensor includes a first far-infrared sensor to acquire far-infrared information on the object before heated by the heating device, and a second far-infrared sensor to acquire far-infrared information on the object after heated by the heating device, and
wherein the computer includes a robot control portion to control the picking robot by using 3D shape information on the object.

11. The picking robot system according to claim 10,
wherein the computer:
stores the edge distance information in association with the partial surface shape information each time the object is measured;
when the newly generated edge distance information matches the previously generated edge distance information, omits the heating of the object by the heating device and the acquisition of the far-infrared information by the far-infrared sensor;
interpolates the newly generated edge distance information by using the partial surface shape information corresponding to the previously generated edge distance information; and
generates 3D shape information on the object.

12. A sensing method of measuring 3D shapes of an object comprising:
generating an image of the object based on visual information on the object 30;
extracting an object region occupied by the object in the image;
extracting distance information on an edge part of the object out of distance information on the object to generate edge distance information;
generating a far-infrared image corresponding to the object region based on far-infrared information on the object;
heating the object;
generating a far-infrared image of the object after heating the object;
estimating partial surface shape information on the object based on far-infrared images before and after heating the object;
generating interpolated edge distance information on the object by interpolating edge distance information through the use of the partial surface shape information; and
converting the interpolated edge distance information into 3D shape information.
